(19) United States
(12) Patent Application Publication
(10) Pub. No.: US 2026/0356245 A1
(43) Pub. Date: Nov. 12, 2026

(54) BATTERY THERMAL GRADIENT OBSERVER

(71) Applicant: GM Global Technology Operations LLC, Detroit, MI (US)

(72) Inventors: Shobhit Gupta, Sterling Heights, MI (US); Bharatkumar Hegde, Bloomfield Hills, MI (US); Ibrahim Haskara, Macomb, MI (US)

(21) Appl. No.: 19/203,673

(22) Filed: May 9, 2025

(51) Int. Cl. B60L 58/25; B60L 58/12; B60L 58/16; B60L 58/26; H01M 10/44; H01M 10/48; H01M 10/613; H01M 10/625; H01M 10/6556

(52) U.S. Cl. CPC B60L 58/25; B60L 58/12; B60L 58/16; B60L 58/26; H01M 10/443; H01M 10/486; H01M 10/613; H01M 10/625; H01M 10/6556; B60L 2240/547; B60L 2240/549

(57) ABSTRACT

A battery thermal gradient observer (BTGO) system includes a battery having cells and a cold plate. Sensors detect battery temperature and battery electrical information. A BTGO application obtains sensor information, monitors a battery state of health (SoH), a state of charge (SoC), a voltage, an SoC balance of the cells, a coolant flow, and coolant intake and coolant outlet temperatures. A non-linear thermal model of the battery and a linear model prediction of thermal characteristics of the battery are generated. Then boundary conditions at edges of the battery are adaptively modeled. The system evaluates heat transfer between edges of the battery and internal nodes of the battery. Utilizing the boundary conditions, and linear model prediction, the system monitors hot and cold points within the battery in real-time and dynamically adjusts charging currents and voltages based on observed thermal gradients to enable fast charging without exceeding thermal limits of the battery.

### INTRODUCTION

The present disclosure relates to batteries in vehicles, and more specifically to management of battery temperatures in hybrid electric vehicles (HEVs), plug-in hybrid electric vehicles (PHEVs), and battery-electric vehicles (BEVs). Thermal management of batteries of HEVs, PHEVs, and BEVs typically depend on time and space across battery cells. To electric vehicle (EV) batteries are typically instrumented with at least one surface thermistor which monitors battery thermal information, and utilizing computational flow dynamics (CFD) tools, solves for thermal distribution across the battery.

However, existing CFD models are often computationally complex and limited to offline benchmarking. Accordingly a lumped-model is generally deployed on EVs that is implementable in real-time, but does not capture temperature variations across the space.

Thus, while current battery thermal monitoring technologies achieve their intended purpose, there is a need for a new and improved system and method for battery thermal monitoring that accurately estimates spatial temperatures across battery cells online, in real-time, locally, and which utilizes existing sensors to determine real-time temperature distributions across all cells in a battery, maintain or improve direct current fast charging (DCFC) control and speed, improve battery thermal performance while the battery is providing power to a vehicle or other such battery-powered system, which provides for improved battery thermal management by allowing for temperature uniformity to be maintained, which provides a scalable solution for distinct thermal architectures and cooling strategies, and which maintains or reduces overall system complexity.

### SUMMARY

According to several aspects, a battery thermal gradient observer system includes a battery having one or more cells and a cold plate. The system further includes one or more thermal sensors within the battery, the one or more thermal sensors detecting a temperature of the battery. One or more electrical sensors are electrically connected to the battery, the one or more electrical sensors detecting electrical information about the battery. The system further includes a controller having a processor, a memory, and input/output (I/O) ports. The I/O ports are in communication with the one or more thermal sensors, the one or more electrical sensors, and the battery. The processor executes program code portions stored in the memory. The program code portions include a battery thermal gradient observer (BTGO) application having at least first, second, third, fourth fifth, and sixth control logics. The first control logic obtains the temperature of the battery and for obtaining electrical information about the battery. The second control logic determines, with a battery management system (B M S) of the system, data including at least a battery state of health (SoH), and a battery state of charge (SoC); the BM S also monitoring battery voltage, an SoC balance of the one or more cells, a coolant or air flow; and coolant intake and coolant outlet temperatures of the battery. The third control logic generates, based on BM S data, a non-linear thermal model of the battery. The fourth control logic, from the non-linear thermal model of the battery, generates a linear model prediction of thermal characteristics of the battery. The fifth control logic adaptively models boundary conditions at edges of the battery, and evaluates heat transfer between edges of the battery and internal nodes of the battery. The sixth control logic utilizes the boundary conditions, and the outputs of the linear model prediction to monitor, in real-time, hot and cold points within the battery and dynamically adjust charging currents and voltages based on observed thermal gradients to enable fast charging without exceeding thermal limits of the battery.

In another aspect of the present disclosure the third control logic further includes control logic that utilizes a thermal gradient observer to estimate the hot and cold points within the battery by using temperature data from the one or more thermal sensors as feedback to a linearly transformed partial differential equation (PDE)-based battery thermal model.

In another aspect of the present disclosure, the system generates battery control inputs including: battery current I_{batt}, coolant inlet temperature

$${T}_{clnt}^{int} ,$$

coolant outlet temperature

$${T}_{clnt}^{out} ,$$

and ambient temperature T_{amb} at a particular point in time t and generates battery state information including at least: battery SoC and a location of one or more cells within the battery.

In another aspect of the present disclosure the system generates a high fidelity non-linear thermal model prediction state input according to:

$$\overline{x} = {\{ {T}_{batt}^{ij} \}}^{T} ∀ i , j ∈ {Γ}_{b att} ,$$

where T_{batt} is a surface temperature of the battery at a location of the thermal sensor, and the high fidelity non-linear thermal model prediction state output x̅ generates temperature predictions at each node (i,j) of the cell, where cell surface is repressed by Γ_{batt}.

In another aspect of the present disclosure the system generates the linear model prediction of thermal characteristics of the battery according to:

\hat{\dot{x}}=A(Θ)\hat{x}+B(Θ)u+K(y−ŷ),

where A(Θ) is a system matrix that models heat transfer across cells, incorporating heat generation due to battery internal resistance, and B(Θ) is a controls matrix that models boundary conditions at each of the edges of the battery that evaluates heat transfer between the edges of the battery and internal nodes of the battery, K defines a gain matrix, y is a sensor measurement matrix, and ŷ defines a linear model prediction at the location of the thermal sensor, such that K(y−ŷ) is a calculated deviation and adaptation to thermal sensor measurements.

In another aspect of the present disclosure the gain matrix K corrects the linear model predictions with feedback from actual real-time thermal sensor measurements, y is generated by the battery and includes all thermal sensor measurements that are provided as feedback to the linear model for corrections, and the sensor measurement matrix y includes T_{batt}, which is a surface temperature of the battery at the thermal sensor location.

In another aspect of the present disclosure the fifth control logic calculates boundary conditions at physical edges of each cell of the battery, monitors an internal resistance of each cell and current collector of the battery; and outputs the boundary conditions and internal resistance information to a reduced order 2-dimensional heat diffusion equation represented as:

\dot{x}=A(Θ)x+B(Θ)u.

In another aspect of the present disclosure the system further divides the battery into one or more grids to identify locations of the one or more cells within the battery, the locations of the thermal sensor and the cold plate, for thermal modeling, determines a thermal observability of each of the one or more cells; and upon determining that a cell of the one or more cells is insufficiently observable, executes the control logic that divides the battery into one or more grids recursively until the thermal observability of each of the one or more cells is sufficiently observable; and upon determining that each of the one or more cells is sufficiently observable, integrating control inputs and location information about each of the one or more cells to generate hot and cold point information.

In another aspect of the present disclosure the system utilizes a battery thermal management system (BTMS) to target the hot and cold points for thermal management; and dynamically adjusts battery charging currents to alter thermal loads applied to each of the one or more cells, and specifically to alter thermal loads on each of the hot and cold points.

In another aspect of the present disclosure the control logic for dynamically adjusting battery charging currents further includes: control logic that maintains an average root-mean-square error (RMSEavg) between temperatures of each of the one or more cells of the battery within approximately one degree Celsius.

In another aspect of the present disclosure a battery thermal gradient observer method includes: detecting a temperature of a battery having one or more cells and a cold plate with one or more thermal sensors within the battery, and detecting electrical information about the battery with one or more electrical sensors electrically connected to the battery. The method further includes executing, with a processor of a controller, program code portions stored in memory of the controller. The controller has input/output (I/O) ports in communication with the one or more thermal sensors and the one or more electrical sensors. The program code portions include a battery thermal gradient observer (BTGO) application comprising control logic for: obtaining the temperature of the battery and obtaining electrical information about the battery, and for determining, with a battery management system (BMS), data including at least a battery state of health (SoH), and a battery state of charge (SoC). The BMS also monitors battery voltage, an SoC balance of the one or more cells, a coolant or air flow; and coolant intake and coolant outlet temperatures of the battery. The program code portions further generate, based on B M S data, a non-linear thermal model of the battery, generate, from the non-linear thermal model of the battery, a linear model prediction of thermal characteristics of the battery, adaptively model boundary conditions at edges of the battery, and evaluate heat transfer between edges of the battery and internal nodes of the battery. The program code portions also monitor in real-time, with the boundary conditions, and the outputs of the linear model prediction, hot and cold points within the battery and dynamically adjust charging currents and voltages based on observed thermal gradients to enable fast charging without exceeding thermal limits of the battery.

In another aspect of the present disclosure the method further includes estimating, via a thermal gradient observer, the hot and cold points within the battery by using temperature data from the one or more thermal sensors as feedback to a linearly transformed partial differential equation (PDE)-based battery thermal model.

In another aspect of the present disclosure the method further includes generating battery control inputs including: battery current I_{batt}, coolant inlet temperature

$${T}_{clnt}^{i n} ,$$

coolant outlet temperature

$${T}_{clnt}^{out} ,$$

and ambient temperature T_{amb} at a particular point in time t; and generating battery state information including at least: battery SoC and a location of one or more cells within the battery.

In another aspect of the present disclosure the method further includes generating a high fidelity non-linear thermal model prediction state input according to:

$$\overline{x} = {\{ {T}_{batt}^{ij} \}}^{T} ∀ i , j ∈ {Γ}_{batt} ,$$

where T_{batt} is a surface temperature of the battery at a location of the thermal sensor, and the high fidelity non-linear thermal model prediction state output x̅ generates temperature predictions at each node (i,j) of the cell, where cell surface is repressed by Γ_{batt}.

In another aspect of the present disclosure the method further includes generating the linear model prediction of thermal characteristics of the battery according to:

\hat{\dot{x}}=A(Θ)\hat{x}+B(Θ)u+K(y−ŷ),

where A(Θ) is a system matrix that models heat transfer across cells, incorporating heat generation due to battery internal resistance, and B(Θ) is a controls matrix that models boundary conditions at each of the edges of the battery that evaluates heat transfer between the edges of the battery and internal nodes of the battery, K defines a gain matrix, y is a sensor measurement matrix, and ŷ defines a linear model prediction at the location of the thermal sensor, such that K(y−ŷ) is a calculated deviation and adaptation to thermal sensor measurements.

In another aspect of the present disclosure the method further includes correcting, with the gain matrix K, the linear model predictions with feedback from actual real-time thermal sensor measurements, y is generated by the battery and includes all thermal sensor measurements that are provided as feedback to the linear model for corrections, and the sensor measurement matrix y includes T_{batt}, which is a surface temperature of the battery at the thermal sensor location.

In another aspect of the present disclosure the method further includes calculating boundary conditions at physical edges of each cell of the battery; monitoring an internal resistance of each cell and current collector of the battery; and outputting the boundary conditions and internal resistance information to a reduced order 2-dimensional heat diffusion equation represented as:

\dot{x}=A(Θ)x+B(Θ)u.

In another aspect of the present disclosure the method further includes dividing the battery into one or more grids to identify locations of the one or more cells within the battery, the locations of the thermal sensor and the cold plate, for thermal modeling; determining a thermal observability of each of the one or more cells; and upon determining that a cell of the one or more cells is insufficiently observable, executing the control logic that divides the battery into one or more grids recursively until the thermal observability of each of the one or more cells is sufficiently observable; and upon determining that each of the one or more cells is sufficiently observable, integrating control inputs and location information about each of the one or more cells to generate hot and cold point information.

In another aspect of the present disclosure the method further includes targeting, via a battery thermal management system (BTMS), the hot and cold points for thermal management; dynamically adjusting battery charging currents to alter thermal loads applied to each of the one or more cells, and specifically to alter thermal loads on each of the hot and cold points; and maintaining an average root-mean-square error (RMSEavg) between temperatures of each of the one or more cells of the battery within approximately one degree Celsius.

In another aspect of the present disclosure a battery thermal gradient observer method includes: detecting a temperature of a battery having one or more cells and a cold plate with one or more thermal sensors within the battery; detecting electrical information about the battery with one or more electrical sensors electrically connected to the battery; and executing, with a processor of a controller, program code portions stored in memory of the controller. The controller has input/output (I/O) ports in communication with the one or more thermal sensors and the one or more electrical sensors. The program code portions include a battery thermal gradient observer (BTGO) application having control logic for: obtaining the temperature of the battery and obtaining electrical information about the battery; and for determining, with a battery management system (BMS), data including at least a battery state of health (SoH), and a battery state of charge (SoC); the BMS also monitoring battery voltage, an SoC balance of the one or more cells, a coolant or air flow; and coolant intake and coolant outlet temperatures of the battery. The program code portions further include control logic for generating, based on BMS data, a non-linear thermal model of the battery, including: estimating, via a thermal gradient observer, the hot and cold points within the battery by using temperature data from the one or more thermal sensors as feedback to a linearly transformed partial differential equation (PDE)-based battery thermal model. The program code portions further include control logic for generating battery control inputs including: battery current I_{batt}, coolant inlet temperature

$${T}_{clnt}^{in} ,$$

coolant outlet temperature

$${T}_{clnt}^{out} ,$$

and ambient temperature T_{amb} at a particular point in time t; and generating battery state information including at least: battery SoC and a location of one or more cells within the battery. The program code portions further include control logic for generating a high fidelity non-linear thermal model prediction state input according to:

$$\overline{x} = {\{ {T}_{batt}^{ij} \}}^{T} ∀ i , j ∈ {Γ}_{batt} ,$$

where T_{batt} is a surface temperature of the battery at a location of the thermal sensor, and the high fidelity non-linear thermal model prediction state output x̅ generates temperature predictions at each node (i,j) of the cell, where cell surface is repressed by Γ_{batt}. The program code portions further include control logic for generating, from the non-linear thermal model of the battery, a linear model prediction of thermal characteristics of the battery, including: generating the linear model prediction of thermal characteristics of the battery according to: \hat{\dot{x}}=A(Θ)x̅+B(Θ)u+K(y−ŷ), where A(Θ) is a system matrix that models heat transfer across cells, incorporating heat generation due to battery internal resistance, and B(Θ) is a controls matrix that models boundary conditions at each of the edges of the battery that evaluates heat transfer between the edges of the battery and internal nodes of the battery, K defines a gain matrix, y is a sensor measurement matrix, and ŷ defines a linear model prediction at the location of the thermal sensor, such that K(y−ŷ) is a calculated deviation and adaptation to thermal sensor measurements. The program code portions further include control logic for correcting, with the gain matrix K, the linear model predictions with feedback from actual real-time thermal sensor measurements, y is generated by the battery and includes all thermal sensor measurements that are provided as feedback to the linear model for corrections, and the sensor measurement matrix y includes T_{batt}, which is a surface temperature of the battery at the thermal sensor location. The program code portions further include control logic for adaptively modeling boundary conditions at edges of the battery, and evaluating heat transfer between edges of the battery and internal nodes of the battery, including: calculating boundary conditions at physical edges of each cell of the battery; monitoring an internal resistance of each cell and current collector of the battery; and outputting the boundary conditions and internal resistance information to a reduced order 2-dimensional heat diffusion equation represented as:

\dot{x}=A(Θ)x+B(Θ)u.

The program code portions further include control logic for monitoring in real-time, with the boundary conditions, and the outputs of the linear model prediction, hot and cold points within the battery and dynamically adjusting charging currents and voltages based on observed thermal gradients to enable fast charging without exceeding thermal limits of the battery, including: dividing the battery into one or more grids to identify locations of the one or more cells within the battery, the locations of the thermal sensor and the cold plate, for thermal modeling. The program code portions further include control logic for determining a thermal observability of each of the one or more cells; and upon determining that a cell of the one or more cells is insufficiently observable, executing the control logic that divides the battery into one or more grids recursively until the thermal observability of each of the one or more cells is sufficiently observable; and upon determining that each of the one or more cells is sufficiently observable, integrating control inputs and location information about each of the one or more cells to generate hot and cold point information. The program code portions further include control logic for targeting, via a battery thermal management system (BTMS), the hot and cold points for thermal management, and for dynamically adjusting battery charging currents to alter thermal loads applied to each of the one or more cells, and specifically to alter thermal loads on each of the hot and cold points. The program code portions further include control logic for maintaining an average root-mean-square error (RMSEavg) between temperatures of each of the one or more cells of the battery within approximately one degree Celsius.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a battery thermal gradient observer system in an exemplary vehicle according to an exemplary embodiment;

FIG. 2 is a flowchart depicting logical flow of the battery thermal gradient observer of FIG. 1 according to an exemplary embodiment; and

FIG. 3 is a flowchart depicting the logical flow of the battery thermal gradient observer of FIG. 2 in a battery management system (BMS) according to an exemplary embodiment.

### DETAILED DESCRIPTION

The following description is merely exemplary in nature and is not intended to limit the present disclosure, application, or uses.

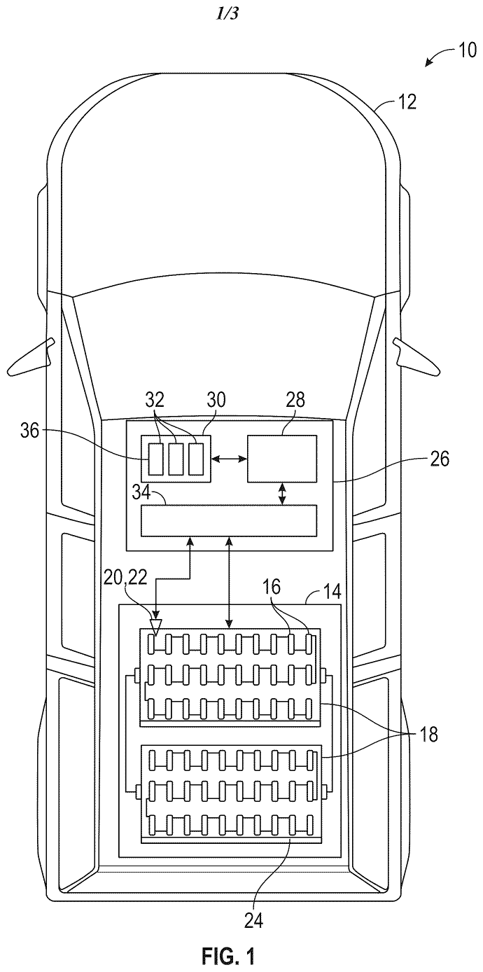

Referring to FIG. 1, a schematic diagram of a system 10 having a battery thermal gradient observer is shown. The system 10 is shown on a vehicle 12, however, it should be appreciated that the system 10 may be used in a variety of different situations and applications without departing from the scope or intent of the present disclosure. In some non-limiting examples, the for battery thermal management may be used on a vehicle 12, in a battery-based power system for a building such as a battery-backup, a battery-assisted or battery-operated aircraft, watercraft, recreational vehicle, or the like. It should further be appreciated that while the vehicle 12 shown is a passenger vehicle 12, the system 10 may operate on any hybrid-electric vehicle (HEV), plug-in hybrid electric vehicle (PHEV), and/or battery-electric vehicle (BEV) without departing from the scope or intent of the present disclosure. Non-limiting examples of the various types of vehicles 12 include: cars, trucks, sport-utility vehicles (SUVs), busses, semi-tractors, tractors used in farming or construction or the like, watercraft, aircraft such as planes or helicopters, or the like.

The system 10 further includes a battery 14 having a plurality of individual battery cells 16, and in some examples battery modules 18. The battery cells 16 may be electrically connected in parallel in series, or in other known configurations. Similarly, battery modules may be electrically connected with one another in parallel, in series, or the like. A thermal sensor 20 is integrated into the battery 14 in at least one location on or within the battery 14. The thermal sensor 20 may be any of a variety of different types of thermal sensors 20 without departing from the scope or intent of the present disclosure. In a non-limiting example, the thermal sensor 20 is a thermistor 22. The thermistor 22 may be any of a variety of different types of thermistors 22 without departing from the scope or intent of the present disclosure. Exemplary thermistors 22 may include negative-temperature-coefficient (NTC) thermistors 22 which have lower resistance at higher temperatures than at lower temperatures, or positive-temperature-coefficient (PTC) thermistors 22 having greater resistance at higher temperatures than at lower temperatures. Additional electrical sensors 23 and/or sensing circuitry electrically connected to or disposed within the battery 14 sense, monitor, and report battery 14 electrical data. The battery 14 electrical data may include a variety of different electrical information including, but not limited to: battery 14 current, battery 14 voltage, battery 14 electrical capacity, battery 14 state of charge (SoC), battery 14 state of health (SoH), and the like. The battery 14 further includes one or more thermal management devices, such as cold plates 24. The cold plates 24 are used to thermally manage battery 14 temperatures, including cell 16 and/or battery module 18 temperatures. In some non-limiting examples, the cold plates 24 may be formed of metal alloys, including aluminum alloys, copper, stainless steel, and the like. Metallic cold plates 24, such as those described above, may be passive or active in nature. Passive cold plates 24 rely on thermal conductivity of the materials from which the passive cold plates 24 are formed, while active cold plates 24 utilize a liquid-cooling system that moves thermal mass from location to location through fluid circulation.

It will be appreciated that management of battery 14 temperatures (including cell 16 and module 18 temperatures) is an important factor in providing optimal battery 14 performance, longevity, avoiding battery 14 failures, and improving customer satisfaction with BEVs, HEVs, and PHEVs, and the like. In additional non-limiting examples, the system 10 of the present disclosure may be applied to standalone battery 14 devices, such as battery 14 backups for infrastructure, battery 14 backups for homes, and any other systems that utilize similar rechargeable high-voltage (HV) batteries 14.

The system 10 further includes one or more controllers 26 in communication with the battery 14 and the thermal sensor 20 or thermistor 22. The controllers 26 are integrated into the vehicle 12. Each of the one or more controllers 26 is a non-generalized, electronic control device having a preprogrammed digital computer or processor 28, non-transitory computer readable medium or memory 30 used to store data such as control logic, software applications, instructions, computer code, data lookup tables, etc., and input/output (I/O) ports 32. Computer readable medium or memory 30 includes any type of medium capable of being accessed by a computer, such as read-only memory (ROM), random access memory (RAM), a hard disk drive, a compact disk (CD), a digital video disc (DVD), or any other type of memory. A “non-transitory” computer readable memory 30 excludes wired, wireless, optical, or other such communication links that transport transitory electrical or other signals. A non-transitory computer readable memory 30 includes media where data can be permanently stored, and media where data can be stored and later overwritten, such as a rewritable optical disc or an erasable memory device. Computer code includes any type of program code, including source code, object code, executable code, and the like. The processor 28 is configured to execute the code or instructions. The vehicle 12 may have additional controllers 26, such as a dedicated Wi-Fi controller, an engine control module, a transmission control module, a body control module, an infotainment control module, a battery control module, or the like. The I/O ports 32 may be configured to communicate via wired communications, wirelessly via Wi-Fi protocols under IEEE 802.11x, or the like without departing from the scope or intent of the present disclosure.

The controller 26 further includes one or more applications 32. An application 34 is a software program configured to perform a specific function or set of functions. The application 34 may include one or more computer programs, software components, sets of instructions, procedures, functions, objects, classes, instances, related data, or portions thereof adapted for implementation in a suitable computer readable program code. The applications 32 may be stored within the memory 30 or in additional or separate memory 30. Examples of applications 32 include audio or video streaming services, games, browsers, social media, etc. In other non-limiting examples, the applications 32 are used to manage body control system functions, suspension control system functions, transmission and/or engine control system functions, and/or battery 14 control functions or the like in an exemplary vehicle 12.

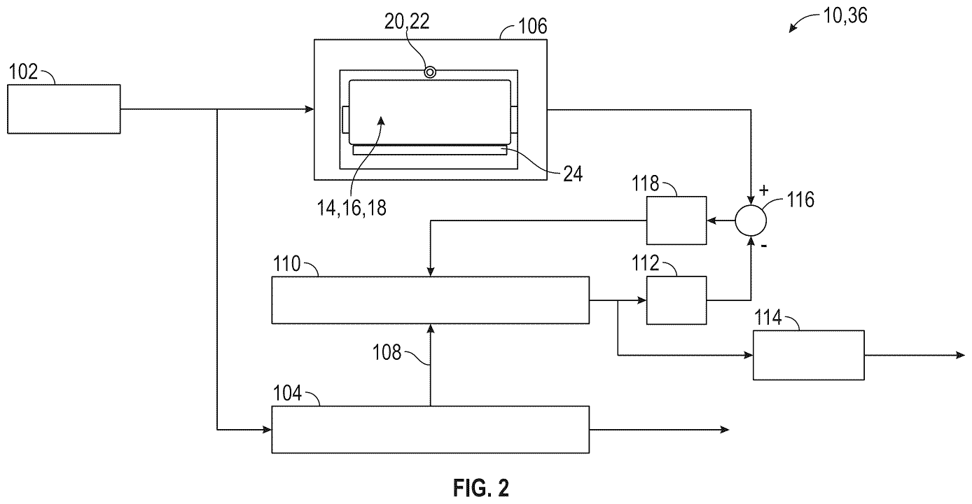

Referring now to FIG. 2 and with continuing reference to FIG. 1, the system 10 utilizes at least one battery thermal gradient observer (BTGO) application 36 stored in memory 30 of the controller 26 of the vehicle 12. The BTGO application 36 monitors and predicts temperature distribution across the battery 14 with preexisting thermal sensors 20. In additional aspects, the BTGO application 36 performs real-time estimation of hot and cold points within the battery 14 under a variety of different circumstances, including direct-current fast-charging (DCFC), as well as during alternating current (AC) charging, discharging, and other modes of battery 14 use and operation. More specifically, the BTGO application 36 utilizes a linear battery 14 thermal gradient observer to estimate hot and cold points or locations within the battery 14, within individual cells 16 and/or within modules 18 of a battery 14 or battery pack through use of existing thermistor 22 measurements as feedback to a linearly transformed partial differential equation (PDE)-based battery 14 thermal model. The BTGO application 36 and system 10 improve battery 14 thermal management by maintaining temperature uniformity across the battery 14 and components (i.e. cells 16 and modules 18) thereof, The BTGO application 36 and system 10 of the present disclosure are scalable to different types of thermal architectures and cooling strategies with minimal alterations, and incorporate available thermal measurements for precise management of battery 14 temperature. More specifically, the observer incorporates battery 14 current, and cold plate temperature information.

In FIG. 2, the BTGO application 36 is shown in the form of a schematic flowchart 100. More specifically, the BTGO application 36 is a portion of and/or works in conjunction with a battery management system (BMS) 102 of the vehicle 12. A BMS 102 is an electronic system that manages functions of a rechargeable battery 14 by facilitating usage and long life of the battery 14 in practical scenarios while monitoring, via the sensors 23 and/or battery 14 sensing circuitry, and estimating the battery's 14 various states, including but not limited to: state of health (SoH), state of charge (SoC), calculating and/or reporting additional data, balancing charging of cells 16 and/or battery modules 18 within the battery 14. In some non-limiting examples, the BMS 102 may monitor battery voltage, current, health of individual cells 16, state of balance of individual cells 16 relative to one another, coolant or air flow for coolant or air-cooled batteries 14, and/or temperature information, including but not limited to: average battery 14 temperature, coolant intake temperatures, coolant output temperatures, and/or temperatures of individual cells 16 or modules 18.

The BMS 102 generates outputs to a non-linear battery 14 thermal model at block 104 and to the battery 14 itself at block 106. These outputs include battery 14 control inputs, represented generally as u which may include battery 14 current I_{batt}, coolant inlet temperature

$${T}_{clnt}^{in} ,$$

coolant outlet temperature

$${T}_{clnt}^{out} ,$$

and ambient temperature T_{amb} at a particular point in time t, which may be represented broadly as:

$$u = {\{ {I}_{batt} , {T}_{clnt}^{in} , {T}_{clnt}^{out} , {T}_{amb} \}}^{T} . \qquad 1.$$

Similarly, the outputs from BMS 102 may include battery 14 state information, represented as Θ, which includes a battery 14 state of charge (SoC), a location of cells 16 and/or modules 18 within the battery 14, and the like, represented in equation form as:

Θ={SOC, . . . }^{T} 2

At block 104, the non-linear thermal model utilizes the battery 14 operation information and battery 14 state information to generate a high fidelity non-linear thermal model prediction state input:

$$\overline{x} = {\{ {T}_{batt}^{ij} \}}^{T} ∀ i , j ∈ {Γ}_{batt} , \qquad 3.$$

where T_{batt} is a surface temperature of the battery 14 at the location of the thermistor 22, and the high fidelity non-linear thermal model prediction state input x̅ generates temperature predictions at each node (i,j) of the cell 16, where cell 16 surface is repressed by Γ_{batt}. Furthermore, outputs of the non-linear battery 14 thermal model are subjected to a linear transformation 108 to generate a linear model prediction of thermal characteristics of the battery 14 at block 110, according to:

\hat{\dot{x}}=A(Θ)\hat{x}+B(Θ)u+K(y−ŷ), 4

where A(Θ) is a system matrix that models heat transfer across cells 16 incorporating heat generation due to battery 14, cell 16 and/or module 18 internal resistance, B(Θ) is a controls matrix that models boundary conditions at each of the edges of the battery 14, cell 16 and/or battery module 18 that evaluates heat transfer between the edges of the battery 14, cell 16 and/or module 18 and internal nodes of the battery 14, cell 16, and/or module 18. In several aspects, the controls matrix B(Θ) is adaptive based on cell 16 placement within a given battery 14 or battery module 18. K defines a gain matrix, that corrects the linear model predictions with feedback from actual real-time thermistor 22 measurements, y is a sensor measurement matrix, generated by the battery 14 at block 106, including all thermal sensor 20, and/or thermistor 22 measurements that are provided as feedback to the linear model for corrections. The sensor measurement matrix y includes T_{batt}, which is a surface temperature of the battery 14 at the thermistor 22 location, and ŷ defines a linear model prediction at the location of the thermistor 22 or thermal sensor 20, such that K(y−ŷ) is a calculated deviation and adaptation to thermistor 22 measurements.

Outputs of the linear model prediction at block 110, including the linear model prediction \hat{x} are sent to a measurement matrix C at block 112, as well as to a max-min calculation at block 114. More specifically, at block 112, the measurement matrix C is populated with data from the linear model prediction according to a quantity and location of thermal sensors 20 or thermistors 22 of the system 10. The linear model prediction § is generated by the measurement matrix C at block 112, and subtracted from the sensor measurement matrix y, including T_{batt}, from the battery 14 at block 116. A result from block 116 is then forwarded to block 118, where the gain matrix K is generated, and forwarded to block 110 for use in the linear model prediction.

Referring once more to block 110, the linear model prediction \hat{x} is used as an input to a max−min calculation at block 114, from which a cold battery surface temperature

$${T}_{batt}^{cold}$$

and a hot battery surface temperature

$${T}_{batt}^{hot}$$

are calculated. It should be appreciated that the hot battery surface temperature

$${T}_{batt}^{hot}$$

is greater than the cold battery surface temperature

$${T}_{batt}^{cold} .$$

That is, the system 10 and BTGO application 36 integrate thermistor 22 and cold plate 24 temperatures to predict hot and cold points of the battery 14. Parameters in the linear observer system 10 define locations of the hot and cold points in the battery 14, such as where a particular cell 16 or module 18 of the battery 14 has a locally hot or cold spot. The system 10 and BTGO application 36 considers the physical location(s) of the thermal sensors 20 or thermistors 22 in the battery 14, and adapt for distinct or different battery 14, cell 16 and/or battery module 18 configurations. The system 10 and BTGO application 36 incorporate non-uniform heat generation and thermal conductivity information relating to the specific structure and configuration of each battery 14 of the system 10.

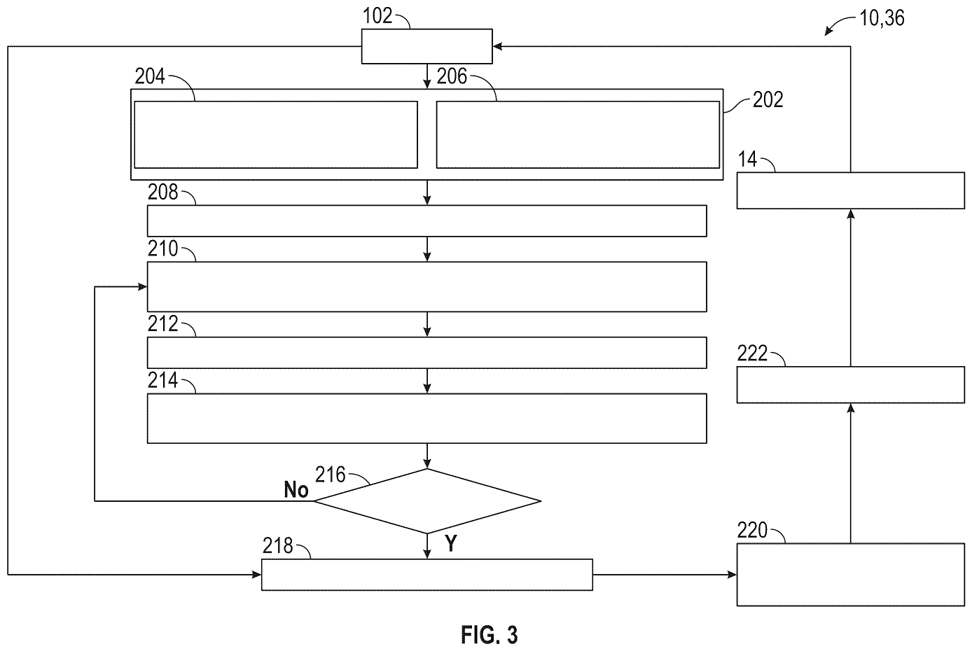

Referring now to FIG. 3 and with continuing reference to FIGS. 1 and 2, the battery thermal gradient observer (BTGO application 36 is shown in additional detail in flowchart form. The BTGO APPLICATION 36 begins at the BM S 102, which, as previously noted, generates control inputs u, and battery 14 state information, represented as Θ. Subsequently, within block 202, an internal resistance of each cell 16 and current collectors is obtained at block 204. Similarly, at block 206 within block 202, boundary conditions at physical edges of each cell 16 are calculated. The boundary conditions Q may incorporate a variety of different types of data without departing from the scope or intent of the present disclosure. In some examples, the boundary conditions \dot{Q} may include, but are not limited to: a general boundary condition

$${\dot{Q}}_{batt}^{gen}$$

of the battery 14, boundary conditions of a battery 14 anode

$${\dot{Q}}_{Anode}^{gen} ,$$

and boundary conditions of a battery 14 cathode

$${\dot{Q}}_{Cathode}^{gen} .$$

The different boundary conditions model the non-homogenous heat transfer at the edges because of materials of different thermal conductivity across the battery 14. The boundary conditions \dot{Q} generally incorporate information regarding different types of battery 14 cooling systems, such as liquid cooling, air cooling, and the like. The boundary conditions \dot{Q} of the battery 14 at edges of each cell 16 define factors used in changing ambient temperature-based thermal management strategies of the system 10 and BTGO application 36.

The boundary condition information \dot{Q} and internal resistance of the cell and current collectors from block 202 are forwarded to block 208, and used as input to a reduced order 2-dimensional heat diffusion equation that is a spatially-resolved thermal model used to perform temperature-aware direct-current fast charging (DCFC) control, without the need for an offline-evaluated thermal offset. The reduced order 2-dimensional heat diffusion equation is a linear system that may be depicted as:

\dot{x}=A(Θ)x+B(Θ)u 5

Results of the calculations at block 208 are forwarded to block 210. At block 210, each battery 14 module 18 is divided into grids to identify cell 16 locations for thermal modeling. The location of individual cells 16 is captured by Θ, which allows modeling of different cell 16 behaviors in a given battery 14 or battery module 18. The observer of the BTGO application 36 and system 10 is also battery 14 chemistry agnostic, and parameters of the system 10 and BTGO application 36 may therefore be transformed to function properly with any battery 14 structure and type. At block 212, the system 10 and BTGO application 36 identify nodes for thermistor 22 and cold plate 24 locations. Subsequently, at block 214, the observer is initialized with spatial interpolation between the thermistor 22 location and cold plate 24 temperature at temperature=0.

At block 216, the system 10 and BTGO application 36 determines whether there is thermal observability for a given cell 16. Observability of each cell 16 is dependent upon a variety of factors, including but not limited to: cell 16 location, thermal sensor 20 or thermistor 22 location relative to cell 16 location, and the like. The linear system is deemed observable if the internal state of the system 10 is determined using the input and output signals during a finite interval of time. Upon determining that the observability of a cell 16 is insufficient, the system 10 and BTGO application proceed back to block 210, where each battery module 18 is divided into grids, and cell 16 locations within the grids of the battery module 18 are identified once more for thermal modeling. By contrast, upon determining at block 216 that there is sufficient observability, the system 10 and BTGO application 36 proceed to block 218. At block 218, the linear observer receives the location information of the cells 16, thermistor 22, cold plate 24, and the control inputs u from the BMS 102, including battery 14 current I_{batt}, coolant inlet temperature

$${T}_{clnt}^{in} ,$$

coolant outlet temperature

$${T}_{clnt}^{out} ,$$

and ambient temperature T_{amb} at a particular point in time T, and integrates the control inputs and the location information to generate hot and cold point information

$${T}_{batt}^{hot} , {T}_{batt}^{cold} .$$

At block 220, the system 10 and BTGO application 36 utilize a bettery thermal management system (BTMS) to target the hot and cold points

$${T}_{batt}^{hot} , {T}_{batt}^{cold}$$

to ensure uniform temperature distribution by dynamically adjusting charging currents during, for example, DCFC control at block 222, thereby altering thermal loads applied to each of the cells 16, and specifically to each of the hot and cold points

$${T}_{batt}^{hot} , {T}_{batt}^{cold} .$$

In several aspects, charge current management may be depicted as:

$${I}_{cold}^{lim} = f ( {T}_{batt}^{cold} , SOC ) , and \qquad 6$$

$${I}_{hot}^{lim} = f ( {T}_{batt}^{hot} , SOC ) . \qquad 7$$

The DCFC control operates to maintain the current or charging and/or discharging speed to maintain all cells 16 of the battery within a predefined range of optimized temperatures, and to maintain the cells 16 at substantially similar temperatures as one another. In a non-limiting example, the root-mean-square error average (RMSEavg) between the temperatures of each cell 16 maintained in the manner described herein may be approximately one (1) degree Celsius. Current or charging commands from the DCFC control at block 222 are sent to the battery 14, which subsequently generates data outputs to the BMS 102 as described in additional detail with respect to FIG. 2 above.

A system 10 and BTGO application 36 of the present disclosure offers several advantages. These include the ability to detect thermal gradients in a battery 14 using a limited distributed thermal sensor 20 array with BMS 102 measurements. The system 10 and BTGO application 36 further provide for real-time monitoring of hot and cold points in the battery 14 during DCFC, thereby enabling dynamic adjustment of charging parameters to ensure battery 14 longevity and performance optimization. The system 10 and BTGO application 36 adaptively estimate thermal gradients identify thermal bottlenecks and hotspots that may limit possible charging speeds and enabling targeted cell 16 cooling while providing for dynamic charging current adjustment and voltages based on observed thermal gradients, enabling faster charging without exceeding hardware and/or software-based thermal limits of the battery 14. The system 10 and BTGO application 36 also provide a way to adaptively apply different cooling systems, such as liquid, air, etc., via boundary conditions, while being chemistry-agnostic and adaptable to different thermal materials even in the presence of one or more thermal sensor 20 or thermistor 22 failures.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A battery thermal gradient observer system comprising:
a battery having one or more cells and a cold plate;
one or more thermal sensors within the battery, the one or more thermal sensors detecting a temperature of the battery;
one or more electrical sensors electrically connected to the battery, the one or more electrical sensors detecting electrical information about the battery;
a controller having a processor, a memory, and input/output (I/O) ports, the I/O ports in communication with the one or more thermal sensors, the one or more electrical sensors, and the battery, the processor executing program code portions stored in the memory, the program code portions including a battery thermal gradient observer (BTGO) application comprising:
a first control logic for obtaining the temperature of the battery and for obtaining electrical information about the battery;
a second control logic for determining, with a battery management system (BM S) of the system, data including at least a battery state of health (SoH), and a battery state of charge (SoC); the BM S also monitoring battery voltage, an SoC balance of the one or more cells, a coolant or air flow; and coolant intake and coolant outlet temperatures of the battery;
a third control logic for generating, based on BMS data, a non-linear thermal model of the battery;
a fourth control logic that, from the non-linear thermal model of the battery, generates a linear model prediction of thermal characteristics of the battery;
a fifth control logic that adaptively models boundary conditions at edges of the battery, and evaluates heat transfer between edges of the battery and internal nodes of the battery; and
a sixth control logic that utilizes the boundary conditions, and the outputs of the linear model prediction to monitor, in real-time, hot and cold points within the battery and dynamically adjust charging currents and voltages based on observed thermal gradients to enable fast charging without exceeding thermal limits of the battery.

2. The system of claim 1, wherein the third control logic further comprises:
control logic that utilizes a thermal gradient observer to estimate the hot and cold points within the battery by using temperature data from the one or more thermal sensors as feedback to a linearly transformed partial differential equation (PDE)-based battery thermal model.

3. The system of claim 2, further comprising:
control logic generates battery control inputs including: battery current I_{batt}, coolant inlet temperature
$${T}_{clnt}^{in} ,$$
coolant outlet temperature
$${T}_{clnt}^{out} ,$$
and ambient temperature T_{amb} at a particular point in time t; and
control logic that generates battery state information including at least: battery SoC and a location of one or more cells within the battery.

4. The system of claim 3, further comprising:
control logic for generating a high fidelity non-linear thermal model prediction state input according to:
$$\overline{x} = {\{ {T}_{batt}^{ij} \}}^{T} ∀ i , j ∈ {Γ}_{batt} ,$$
where T_{batt} is a surface temperature of the battery at a location of the thermal sensor, and the high fidelity non-linear thermal model prediction state input x̅ generates temperature predictions at each node (i,j) of the cell, where cell surface is repressed by Γ_{batt}.

5. The system of claim 4, further comprising:
control logic that generates the linear model prediction of thermal characteristics of the battery according to:
\hat{\dot{x}}=A(Θ)\hat{x}+B(Θ)u+K(y−ŷ),
where A(Θ) is a system matrix that models heat transfer across cells, incorporating heat generation due to battery internal resistance, and B(Θ) is a controls matrix that models boundary conditions at each of the edges of the battery that evaluates heat transfer between the edges of the battery and internal nodes of the battery, K defines a gain matrix, y is a sensor measurement matrix, and ŷ defines a linear model prediction at the location of the thermal sensor, such that K(y−ŷ) is a calculated deviation and adaptation to thermal sensor measurements.

6. The system of claim 5, wherein the gain matrix K corrects the linear model predictions with feedback from actual real-time thermal sensor measurements, y is generated by the battery and includes all thermal sensor measurements that are provided as feedback to the linear model for corrections, and the sensor measurement matrix y includes T_{batt}, which is a surface temperature of the battery at the thermal sensor location.

7. The system of claim 6, wherein the fifth control logic further comprises:
control logic that calculates boundary conditions at physical edges of each cell of the battery;
control logic that monitors an internal resistance of each cell and current collector of the battery; and
control logic that outputs the boundary conditions and internal resistance information to a reduced order 2-dimensional heat diffusion equation represented as:
\dot{x}=A(Θ)x+B(Θ)u.

8. The system of claim 7, wherein the sixth control logic further comprises:
control logic that divides the battery into one or more grids to identify locations of the one or more cells within the battery, the locations of the thermal sensor and the cold plate, for thermal modeling;
control logic that determines a thermal observability of each of the one or more cells; and
upon determining that a cell of the one or more cells is insufficiently observable, executing the control logic that divides the battery into one or more grids recursively until the thermal observability of each of the one or more cells is sufficiently observable; and
upon determining that each of the one or more cells is sufficiently observable, integrating control inputs and location information about each of the one or more cells to generate hot and cold point information.

9. The system of claim 8, further comprising:
control logic for utilizing a battery thermal management system (BTMS) to target the hot and cold points for thermal management; and
control logic for dynamically adjusting battery charging currents to alter thermal loads applied to each of the one or more cells, and specifically to alter thermal loads on each of the hot and cold points.

10. The system of claim 9, wherein the control logic for dynamically adjusting battery charging currents further comprises:
control logic that maintains an average root-mean-square error (RMSEavg) between temperatures of each of the one or more cells of the battery within approximately one degree Celsius.

11. A battery thermal gradient observer method comprising:
detecting a temperature of a battery having one or more cells and a cold plate with one or more thermal sensors within the battery;
detecting electrical information about the battery with one or more electrical sensors electrically connected to the battery;
executing, with a processor of a controller, program code portions stored in memory of the controller, the controller having input/output (I/O) ports in communication with the one or more thermal sensors and the one or more electrical sensors, the program code portions including a battery thermal gradient observer (BTGO) application comprising control logic for:
obtaining the temperature of the battery and obtaining electrical information about the battery;
determining, with a battery management system (BMS) of the system, data including at least a battery state of health (SoH), and a battery state of charge (SoC); the BMS also monitoring battery voltage, an SoC balance of the one or more cells, a coolant or air flow; and coolant intake and coolant outlet temperatures of the battery;
generating, based on BMS data, a non-linear thermal model of the battery;
generating, from the non-linear thermal model of the battery, a linear model prediction of thermal characteristics of the battery;
adaptively modeling boundary conditions at edges of the battery, and evaluating heat transfer between edges of the battery and internal nodes of the battery; and
monitoring in real-time, with the boundary conditions, and the outputs of the linear model prediction, hot and cold points within the battery and dynamically adjust charging currents and voltages based on observed thermal gradients to enable fast charging without exceeding thermal limits of the battery.

12. The method of claim 11, further comprising:
estimating, via a thermal gradient observer, the hot and cold points within the battery by using temperature data from the one or more thermal sensors as feedback to a linearly transformed partial differential equation (PDE)-based battery thermal model.

13. The method of claim 12, further comprising:
generating battery control inputs including: battery current I_{batt}, coolant inlet temperature
$${T}_{clnt}^{in} ,$$
coolant outlet temperature
$${T}_{clnt}^{out} ,$$
and ambient temperature T_{amb} at a particular point in time t; and
generating battery state information including at least: battery SoC and a location of one or more cells within the battery.

14. The method of claim 13, further comprising:
generating a high fidelity non-linear thermal model prediction state input according to:
$$\overline{x} = {\{ {T}_{batt}^{ij} \}}^{T} ∀ i , j ∈ {Γ}_{batt} ,$$
where T_{batt} is a surface temperature of the battery at a location of the thermal sensor, and the high fidelity non-linear thermal model prediction state input x̅ generates temperature predictions at each node (i,j) of the cell, where cell surface is repressed by Γ_{batt}.

15. The method of claim 14, further comprising:
generating the linear model prediction of thermal characteristics of the battery according to:
\hat{\dot{x}}=A(Θ)\hat{x}+B(Θ)u+K(y−ŷ),
where A(Θ) is a system matrix that models heat transfer across cells, incorporating heat generation due to battery internal resistance, and B(Θ) is a controls matrix that models boundary conditions at each of the edges of the battery that evaluates heat transfer between the edges of the battery and internal nodes of the battery, K defines a gain matrix, y is a sensor measurement matrix, and ŷ defines a linear model prediction at the location of the thermal sensor, such that K(y−ŷ) is a calculated deviation and adaptation to thermal sensor measurements.

16. The method of claim 15, further comprising:
correcting, with the gain matrix K, the linear model predictions with feedback from actual real-time thermal sensor measurements, y is generated by the battery and includes all thermal sensor measurements that are provided as feedback to the linear model for corrections, and the sensor measurement matrix y includes T_{batt}, which is a surface temperature of the battery at the thermal sensor location.

17. The method of claim 16, further comprising:
calculating boundary conditions at physical edges of each cell of the battery;
monitoring an internal resistance of each cell and current collector of the battery; and
outputting the boundary conditions and internal resistance information to a reduced order 2-dimensional heat diffusion equation represented as:
\dot{x}=A(Θ)x+B(Θ)u.

18. The method of claim 17, further comprising:
dividing the battery into one or more grids to identify locations of the one or more cells within the battery, the locations of the thermal sensor and the cold plate, for thermal modeling;
determining a thermal observability of each of the one or more cells; and
upon determining that a cell of the one or more cells is insufficiently observable, executing the control logic that divides the battery into one or more grids recursively until the thermal observability of each of the one or more cells is sufficiently observable; and
upon determining that each of the one or more cells is sufficiently observable, integrating control inputs and location information about each of the one or more cells to generate hot and cold point information.

19. The method of claim 18, further comprising:
targeting, via a battery thermal management system (BTMS), the hot and cold points for thermal management;
dynamically adjusting battery charging currents to alter thermal loads applied to each of the one or more cells, and specifically to alter thermal loads on each of the hot and cold points; and
maintaining an average root-mean-square error (RMSEavg) between temperatures of each of the one or more cells of the battery within approximately one degree Celsius.

20. A battery thermal gradient observer method comprising:
detecting a temperature of a battery having one or more cells and a cold plate with one or more thermal sensors within the battery;
detecting electrical information about the battery with one or more electrical sensors electrically connected to the battery;
executing, with a processor of a controller, program code portions stored in memory of the controller, the controller having input/output (I/O) ports in communication with the one or more thermal sensors and the one or more electrical sensors, the program code portions including a battery thermal gradient observer (BTGO) application comprising control logic for:
obtaining the temperature of the battery and obtaining electrical information about the battery;
determining, with a battery management system (BMS), data including at least a battery state of health (SoH), and a battery state of charge (SoC); the BMS also monitoring battery voltage, an SoC balance of the one or more cells, a coolant or air flow; and coolant intake and coolant outlet temperatures of the battery;
generating, based on BMS data, a non-linear thermal model of the battery, including:
estimating, via a thermal gradient observer, hot and cold points within the battery by using temperature data from the one or more thermal sensors as feedback to a linearly transformed partial differential equation (PDE)-based battery thermal model;
generating battery control inputs including: battery current I_{batt}, coolant inlet temperature
$${T}_{clnt}^{in} ,$$
coolant outlet temperature
$${T}_{clnt}^{out} ,$$
and ambient temperature T_{amb} at a particular point in time t; and
generating battery state information including at least: battery SoC and a location of one or more cells within the battery;
generating a high fidelity non-linear thermal model prediction state input according to:
$$\overline{x} = {\{ {T}_{batt}^{ij} \}}^{T} ∀ i , j ∈ {Γ}_{batt} ,$$
where T_{batt} is a surface temperature of the battery at a location of the thermal sensor, and the high fidelity non-linear thermal model prediction state input x̅ generates temperature predictions at each node (i,j) of the cell, where cell surface is repressed by Γ_{batt};
generating, from the non-linear thermal model of the battery, a linear model prediction of thermal characteristics of the battery, including:
generating the linear model prediction of thermal characteristics of the battery according to:
\hat{\dot{x}}=A(Θ)\hat{x}+B(Θ)u+K(y−ŷ),
where A(Θ) is a system matrix that models heat transfer across cells, incorporating heat generation due to battery internal resistance, and B(Θ) is a controls matrix that models boundary conditions at each edge of the battery that evaluates heat transfer between edges of the battery and internal nodes of the battery, K defines a gain matrix, y is a sensor measurement matrix, and ŷ defines a linear model prediction at the location of the thermal sensor, such that K (y−ŷ) is a calculated deviation and adaptation to thermal sensor measurements;
correcting, with the gain matrix K, the linear model predictions with feedback from actual real-time thermal sensor measurements, y is generated by the battery and includes all thermal sensor measurements that are provided as feedback to the linear model for corrections, and the sensor measurement matrix y includes T_{batt}, which is a surface temperature of the battery at the thermal sensor location;
adaptively modeling boundary conditions at edges of the battery, and evaluating heat transfer between edges of the battery and internal nodes of the battery, including:
calculating boundary conditions at physical edges of each cell of the battery;
monitoring an internal resistance of each cell and current collector of the battery; and
outputting the boundary conditions and internal resistance information to a reduced order 2-dimensional heat diffusion equation represented as:
\dot{x}=A(Θ)x+B(Θ))u; and
monitoring in real-time, with the boundary conditions, and the outputs of the linear model prediction, hot and cold points within the battery and dynamically adjust charging currents and voltages based on observed thermal gradients to enable fast charging without exceeding thermal limits of the battery, including:
dividing the battery into one or more grids to identify locations of the one or more cells within the battery, the locations of the thermal sensor and the cold plate, for thermal modeling;
determining a thermal observability of each of the one or more cells; and
upon determining that a cell of the one or more cells is insufficiently observable, executing the control logic that divides the battery into one or more grids recursively until the thermal observability of each of the one or more cells is sufficiently observable; and
upon determining that each of the one or more cells is sufficiently observable, integrating control inputs and location information about each of the one or more cells to generate hot and cold point information;
targeting, via a battery thermal management system (BTMS), the hot and cold points for thermal management;
dynamically adjusting battery charging currents to alter thermal loads applied to each of the one or more cells, and specifically to alter thermal loads on each of the hot and cold points; and
maintaining an average root-mean-square error (RMSEavg) between temperatures of each of the one or more cells of the battery within approximately one degree Celsius.
